(19) United States
(12) Patent Application Publication
(10) Pub. No.: US 2004/0111380 A2
(43) Pub. Date: Jun. 10, 2004

(54) METHOD, ACCORDING TO WHICH A CUSTOMER ACCESSES MONETARY-VALUE DATA FROM A CHARGING POINT

(76) Inventors: Jurgen Lang, Bergisch-Gladbach (DE); Bernd Meyer, Konigswinter (DE)

Correspondence Address: CONNOLLY BOVE LODGE & HUTZ LLP, SUITE 800, 1990 M STREET NW, WASHINGTON, DC, 20036-3425, US

(21) Appl. No.: 10/258,226

(22) Filed: Nov. 26, 2002

Related U.S. Application Data
(63) A 371 of international application No. PCTDE0101552, filed on Apr. 24, 2001.

(30) Foreign Application Priority Data
Apr. 27, 2000 (DE) 100 20 565.8

(51) Int. Cl. H04K 1/00; H04L 9/00; G06F 17/60

(52) U.S. Cl. 705/77; 705/64

(57) ABSTRACT

### Abstract of the Disclosure

The invention is characterized in that a random number (X) and a payment identification number (PID) which contain information about the customer are generated in the charging point.

### Detailed Description of the Invention

### CROSS REFERENCE TO RELATED APPLICATIONS

This application is a U.S. National Stage entry under 35 U.S.C. § 371 of co-pending International Patent Application No. PCT/DE01/01552, filed on April 24, 2001 by Jurgen Lang, et al. entitled METHOD, ACCORDING TO WHICH A CUSTOMER ACCESSES MONETARY-VALUE DATE FROM A CHARGING POINT and for which priority is claimed under 35 U.S.C. § 119 to Germany Application 100 20 565.8, filed on April 27, 2000.

### BACKGROUND

The invention relates to a method according to which a customer accesses monetary-value data from a loading station.

Especially with payment transactions that are carried out via the Internet, there is a need to pay quickly and securely for services rendered and goods shipped.

Electronic payment transactions have to meet high requirements in terms of data security and user authenticity.

### BRIEF SUMMARY

According to the invention, this objective is achieved in that a random number and a payment identification number containing data about the customer are generated in the loading station.

Additional advantages, special features and an advantageous embodiment of the invention ensue from the subordinate claims and from the representation below of a preferred embodiment with reference to the drawing.

### DESCRIPTION OF THE DRAWINGS

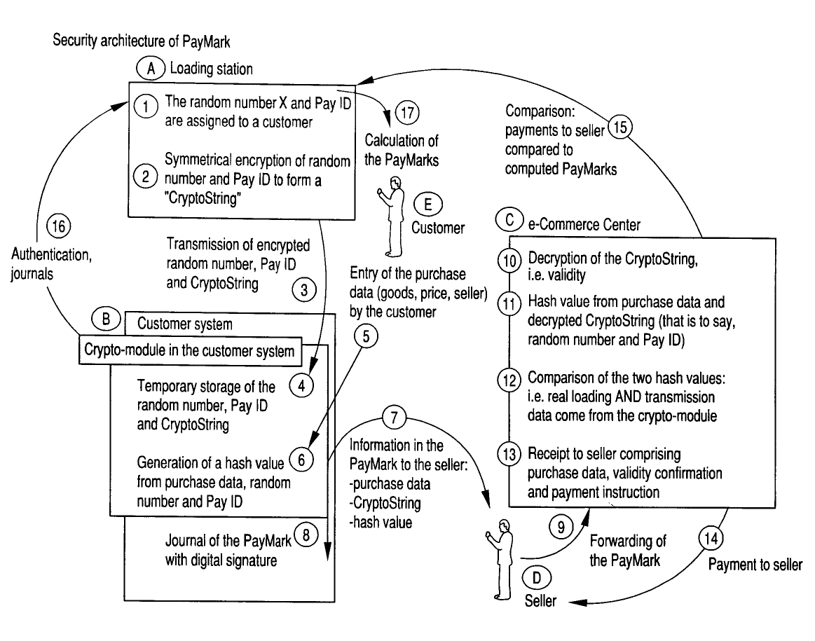

The drawing of FIG. 1 shows a schematic diagram of process steps that can be advantageously integrated into a security architecture of the payment transaction.

### DETAILED DESCRIPTION

The invention relates especially to the production of PayMarks, that is to say, monetary-value crypto-information.

Functional Mode of PCF PayMark

PCF PayMark is an expansion of PC franking (PCF). With a few additions to the system, it is possible to generate so-called PayMarks, that is to say, monetary-value crypto-information, instead of postage indicia. These PayMarks can be submitted, for example, in electronic form within the scope of the e-Commerce Center, but also in another form (for example, paper) to a seller as payment for a purchase transaction. The seller can have the validity of these monetary-value PayMarks verified in an e-Commerce Center and then receives the corresponding value reimbursed from this e-commerce center.

The security architecture of PCF PayMark is configured as follows:

Explanations About the Sequence

In principle, the process shown involves a cyclic process which, depending on whether it is a credit or debit procedure of PCP, is executed regularly or irregularly for reloading debit amounts. The actual start of the cyclic process is the stop that is designated with no. 16 in the figure, namely, the authentication of the customer system vis-à-vis a central "loading station". For reasons of a better overview, however, in this depiction, the cyclic process only starts with the first process step after the authentication has taken place;

1. A random number X and a so-called Pay ID PID containing information about the customer, about his/her creditworthiness for micropayment purchases and about the period of validity of the PID are generated in the loading station

2. In the loading station, the random number X and the Pay ID PID are encrypted (e.g. symmetrically) to form a so-called "CryptoString" in such a way that only the e-Commerce Center is capable of decrypting the random number and the PID on the basis of this CryptoString.

3. The random number X, Pay ID PID and the CryptoString are encrypted in such a way (e.g. asymmetrically) that only the crypto-module in the customer system is capable of decrypting this information.

4. The random number X, the Pay ID PID and the CryptoString are stored temporarily in the crypto-module. Subsequently, the communication with the loading station can be terminated.

5. Within the scope of thc purchase transaction, the customer enters information (e.g. goods/product, price, supplier/seller, date, etc.) into the crypto-module.

6. The crypto-module generates a bash value, among other things, on the basis of the purchase data, the random number, the Pay ID PID (and optionally additional information).

7. The customer system generates a so-called PayMark, that is to say, a character string with crypto-information containing, among other things, the following information: the purchase data in plain text, the temporally stored CryptoString and the generated hash value. This PayMark can be transmitted, for example, electronically to the seller (for example, with an e-mail or on-line via the World-Wide Web), but it can also be transmitted to the seller via other data carriers or else printed out on paper.

8. The crypto-module digitally signs the PayMark with all of the security-relevant information with its own private key and stores it in a journal file in the customer system.

9. The seller receives the PayMark as a monetary-value confirmation for a payment and submits it to the e-Commerce Center for purposes of verification of its validity and for effectuating a payment to him/her. In special embodiments of the system, it is also possible for the PayMark to be transmitted directly to the e-Commerce Center, bypassing the seller.

10. In a first verification step, the CryptoString, which had been encrypted in such a way that only the e-Commerce Center could decrypt it, is decrypted to form the random number X and the Pay ID PID.

11. Like the customer system, the e-Commerce Center now generates a hash value, among other things, on the basis of the transmission-specific data, the random number decrypted from the CryptoString and the Pay ID PID (and optionally additional information).

12. By comparing the hash value that the e-Commerce Center itself has just generated with the hash value contained in the PayMark, it is ascertained whether the (reliable) crypto-module in the customer system was indeed used to produce the PayMark, thus confirming the validity of the PayMark.

13. The e-Commerce Center issues and sends the seller a receipt consisting of the purchase data, the validity confirmation of the PayMark and the confirmation of the payment instruction.

14. The payment transaction to the seller is effectuated, optionally with a time delay.

15. For settlement purposes, the payments of the e-Commerce Center made to the seller are compared to the values that were available to a customer for the production of PayMarks.

16. The values that a customer can use for the production of PayMarks are made available to him/her via the loading station. For this purpose, an authentication of the customer is necessary with which the journal data of the already produced PayMarks (see Item 8) are also transmitted.

17. Depending on the credit or debit process, the produced PayMarks are either charged to the customer ahead of time (loading amount by means of the debit method) or retrospectively on the basis of the journal data. Subsequently, it is possible to continue again with Item 1, that is to say, with the preparation of a new random number X and a new Pay ID PID.

What is Claimed is:

1. A method according to which a customer accesses monetary-value data from a loading station whereby a random number (X) and a payment identification number (PID) containing data about the customer are generated in the loading station, whereby a customer system generates a character string with crypto-information, whereby a seller receives the character string as a monetary-value amount for a payment, whereby the seller submits the character string to an e-Commerce Center for purposes of verification of its validity and for effectuating a payment, whereby the Commerce Center for purpose of verification of its validity and fore effectuating a payment, whereby the Commerce Center decrypts the character string, characterized in that the e-Commerce Center generates a hash value from the random number decrypted from the character string and from the payment identification number (PID).

2. The method according to claim 1, characterized in that, in the loading station, the random number (X) and the payment identification number (PID) are combined to form a cryptographic unit in such a way that only an external e-Commerce Center is capable of decrypting the random number (X)and the payment identification number (PID).

3. The method according to Claim 2, wherein the random number (X), the payment identification number (PID) and the crypto-graphic unit are stored temporarily in a crypto-module.

4. The method according to Claim 3, wherein the customer enters information into the crypto-module during a purchase transaction.

5. The method according to Claim 3, wherein the crypto-module generates the hash value.

6. The method according to Claim 5, wherein the hash value is formed with the inclusion of data of the purchase transaction, of the random number (X) and of the payment identification number (PID).

7. The method according to Claim 2, wherein the character string contains the purchase transaction data in plain text, the cryptographic unit and the hash value.

8. The method according to Claim 3, wherein the crypto-module digitally signs the character string and stores said character string in a journal file.

9. The method according to Claim 1, wherein the character string is transmitted directly to the e-Commerce Center.

10. The method according to Claim 1, wherein the character string is encrypted in such a way that only the e-Commerce Center can decrypt the character string.

11. The method according to Claim 1, wherein the e-Commerce Center, by comparing the hash value that the e-Commerce Center has generated with the hash value contained in the character string, ascertains whether a crypto-module suitable for payment was indeed used to produce the character string.

12. The method according to Claim 1, wherein the e-Commerce Center sends the seller a receipt.

13. The method according to Claim 1, wherein the e-Commerce Center makes a payment to the seller.

14. The method according to Claim 1, wherein payment made to the seller is compared a value that was available to the customer for production of the character string with crypto-information.

15. The method according to Claim 1, wherein the customer receives values that the customer can use for production of character strings with crypto-information.

16. The method according to claim 15, wherein the customer receives the values after an authentication.

17. The method according to Claim 15, wherein the customer pays the monetary sums for the values before the character string with crypto-information is created.

18. The method according to Claim 15, wherein the customer pays the monetary sums for the values after the character string with crypto-information is created.

19. A method for providing customer accesses to monetary-value data from a loading station, comprising:
generating a random number (X) and a payment identification number (PID) configured to contain data about the customer in the loading station;
generating a character string with crypto-information in a customer system;
receiving the character string as a monetary-value amount for a payment by a seller; submitting the character string to an e-Commerce Center by the seller; and
verifying validity of the character string by the e-Commerce Center to effect a payment,

20. The method according to claim 19, wherein, in the loading station, the random number (X) and the payment identification number (PID) are combined to form a cryptographic unit that only an external e-Commerce Center is capable of decrypting the random number (X)and the payment identification number (PID).

21. The method according to claim 20, wherein verifying validity further comprises decrypting the character string; and
generating a hash value from the random number decrypted from the character string; and
from the payment identification number (PID).

22. A system for providing customer accesses to monetary-value data, comprising:
a loading station configured to receive purchase transaction data and transmit encrypted
data about a customer;
a customer system configured to store, create and forward monetary-value data from the data received from the loading station; and
an e-Commerce Center configured receive and validate the monetary-value data forwarded from the customer system.

23. An apparatus for creating a PayMark, comprising:
a loading station configured to receive purchase transaction data and transmit encrypted data about the customer;
a crypto-module configured to provide temporary storage and to generate a hash value for the PayMark; and
a customer system configured to forward the PayMark to an e-Commerce Center.

24. The apparatus of claim 23, wherein the loading station is configured to receive purchase transaction data comprising at least one of goods, price and seller data.

25. The apparatus of claim 23, wherein the encrypted data is at least one of symmetrically encrypted data and asymmetrically encrypted data.

26. The apparatus of claim 23, wherein the loading station is configured to form a cryptostring by symmetrically encrypting a random number and a payment identification number (PID).

27. The apparatus of claim 23, wherein the crypto-module is configured to provide a journal of the PayMark with a digital signature.

28. The apparatus of claim 23, wherein the crypto-module is configured to generate the hash value from at least one of purchase transaction data, a random number and a payment identification number (PID).

29. The apparatus of claim 23, wherein the customer system is configured to transmit a PayMark comprising at least one of purchase transaction data, a cryptostring and the hash value.

30. An apparatus for an e-Commerce Center, comprising:
means for decryption configured to validate a cryptostring;
means for determining hash values from purchase data and a decrypted cryptostring;
means for comparing hash values;
means for generating a receipt; and
means for paying a seller.
